(19) United States
(12) Patent Application Publication
(10) Pub. No.: US 2010/0174563 A1
(43) Pub. Date: Jul. 8, 2010

(54) System and Method for Purchasing Insurance

(76) Inventor: Russel Lazenga, North Miami, FL (US)

Correspondence Address: ROBERT M. SCHWARTZ, P.A., P.O. BOX 221470, HOLLYWOOD, FL, 33022, US

(21) Appl. No.: 12/652,200

(22) Filed: Jan. 5, 2010

Related U.S. Application Data
(60) Provisional application No. 61/142,419, filed on Jan. 5, 2009.

(51) Int. Cl. G06Q 40/00; G06K 15/00; G06Q 20/00; G06Q 30/00; G06F 3/041

(52) U.S. Cl. 705/4; 235/383; 345/173

(57) ABSTRACT

The present invention is a system, device, and method of purchasing insurance from a remote location.

### INDEX TO RELATED APPLICATIONS

This application claims the benefit of U.S. Provisional Patent Application No. 61/142,419 filed Jan. 5, 2009 the disclosure of which is incorporated herein by reference in its entirety.

### BACKGROUND OF THE INVENTION

Although the Internet has improved the ability to purchase insurance, there are still many persons that go to agencies for their purchases.

The present invention simplifies the process of purchasing insurance by providing remote devices through which insurance is purchased.

### SUMMARY OF THE INVENTION

In one embodiment, the present invention is a machine for selecting and purchasing insurance products comprising:

a. a program stored on a computer readable medium;
b. a video display;
c. a communications means;
d. a payment accepting means;
e. a printer, wherein said printer is constructed and arranged to provide receipt for purchase and proof of insurance acceptable in a particular state.

The machine has a program that provides interactive information input and output via video display for the purchase of insurance products. Preferably the video display is a touch screen display.

The machine has a communications means that provides communication with a remote system by telephone, Internet, wireless, or combinations thereof. The remote system can be a single computer or terminal configured to communicate and process insurance purchases with the machine of the invention.

The machine has a payment accepting mechanism that is any of a pliant currency accepter, credit card reader, check imaging and processing mechanism, or combinations thereof.

The printer provides proof of insurance at the time of purchase. The machine, system and method of the present invention also provides proof of insurance that is acceptable for a particular state or states. The user will select in which state they need to show proof of insurance.

The machine further has a removable camera secured thereto. The machine has a flash memory card reader for receiving and transmitting digital images from the camera.

The present invention is also a system for conducting an insurance transaction comprising:

a. providing a machine according to the present invention;
b. selecting a public location to place said machine;
c. placing said machine in said public location.

The present invention is also a method for conducting an insurance transaction comprising the steps of:

a. providing a machine according to the present invention;
b. selecting a public location to place said machine;
c. placing said machine in said public location
d. providing an insurance selection and purchase program on a computer readable medium for said machine;
e. providing an output to indicate proof of purchased insurance.

### BRIEF DESCRIPTION OF THE DRAWING

FIG. 1 is a front view of the machine.

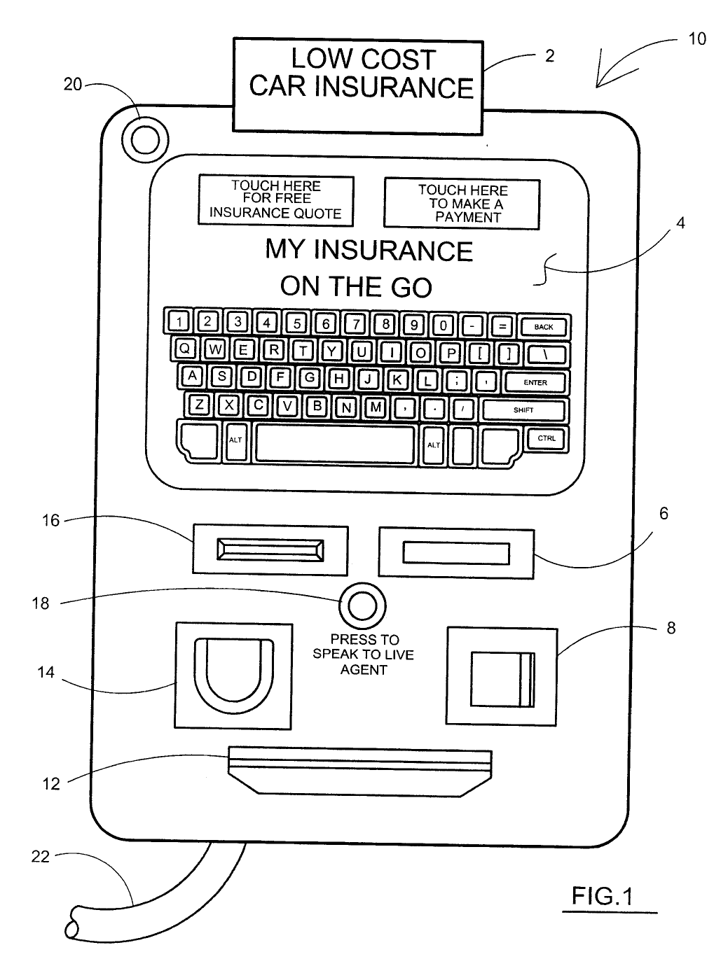

### DETAILED DESCRIPTION OF THE PREFERRED EMBODIMENTS

The present invention is a system and method for the selection, purchase, and maintenance of insurance products. A program stored a computer readable medium and a communications means will interact with a consumer in order to carry out the system and method of the present invention.

In one embodiment, a stand alone terminal device, similar to a conventional automatic teller machine (ATM) style device, is configured with the requisite computer readable medium, an electronic component to read the medium and a communications means. The computer readable medium, electronic component to read the medium, and a communications means are commonly known in the art. The method of the present invention provides identifying suitable retail and/or public establishments to place the stand alone terminal. In one embodiment, the terminals are to be placed in leased space at busy retail establishments (i.e. Wal-Mart, Target, etc.) as well as in front of supermarkets and in check cashing stores. Additionally, machines are placed in auto dealerships and at or near state auto licensing offices. One embodiment of the invention provides for commissions to be paid to the establishment at which the machine is placed.

The terminal device would be similar in size and structure to existing ATM machines; however, the function of the device would be to allow the consumer to purchase insurance products, such as car insurance, and/or pay an insurance bill instantly through the machine.

The terminal device would be constructed and arranged to accept payments, with any one or a combination of: a pliant currency acceptor; conventional electronics and communications to process credit cards; and check electronic imaging and processing mechanisms.

In a preferred embodiment, the terminal device functions with a touch-screen operated computer system linked through the Internet by DSL, cable connection, satellite, or other acceptable communication means, to a centralized insurance agency computer system and the agency's Quick-Quote system, as is commonly used in the insurance industry.

The system would proceed as follows:

By selecting menus on the touch screen, the consumer would have the option to:

1) get an insurance quote;
2) make an insurance payment.
The system would contain a printing mechanism so that customers electing to purchase insurance would be issued a temporary insurance binder card form the device.

The device would contain a custom software package which would walk the customer through the process of obtaining the insurance quote, selecting a policy and obtaining a policy binder. A help button would also be available to connect the customer to a live agent via video-feed.

The device will have identification and verification means as are commonly know. Identification includes, but is not limited to biometric identification such as hand scan, fingerprint, iris scan and the like.

Additionally, to accommodate most insurers' requirements that vehicle photos be obtained prior to issuing coverage, the device would be fitted with a media reader. The media reader in one embodiment is a standard 16-in-1 media reader (capable of reading Standard Digital (SD) and similar digital media cards) as well as a removable digital camera (fitted and secured by lock and key). The merchant housing the machine would be able to remove the camera to take digital photos of the vehicle and insert the media card in the unit. The unit would upload the images and transmit the pictures of the vehicle to the central agency along with the insurance application so that a policy can be issued.

Preferably, the camera is digital so it can download directly to the machine when it is plugged back in after taking pictures. The machine has a multimedia card reader as an additional feature. The multimedia card reader provides that if the merchant has a problem with the built-in camera or wants to use their own, it is available for use. The device is also constructed and arranged to dispense change for the cash payment and print receipts for cash payments.

In sequential steps the method of the present invention is:

1) Screen asks “would you like:
a) an insurance quote or b) to make a payment”
2) If customer selects payment the customer can type in account information and make payment by cash (pliant bill reader) or credit card. Insurance agent is then generally responsible for forwarding payment to insurer
3) If the customer selects an insurance quote the software would take the customer through the questions for the standard insurance application and forward the information to the quick quote system which would furnish the customer the insurer's rates to write that policy.
4) If the customer accepts and the insurer approves the risk then the system will instruct the customer of the payment options and once the payment option is selected the customer will pay by cash or credit card.
5) the system will then print a temporary insurance binder card for use until the insurer issues the policy.
6) If the customer elects to buy comprehensive and collision coverage (coverage for damage to the customer's own vehicle) vehicle photos are required, The camera system we discussed previously would20be used for that function.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A machine for selecting and purchasing insurance products comprising:
a. a program stored on a computer readable medium;
b. a video display;
c. a communications means;
d. a payment accepting means;
e. a printer, wherein said printer is constructed and arranged to provide receipt for purchase and proof of insurance acceptable in a particular state.

2. The machine of claim 1 wherein said program provides interactive information input and output via video display for the purchase of insurance products.

3. The machine of claim 1 wherein said video display is a touch screen display.

4. The machine of claim 1 wherein said communications means provides communication with a remote system by telephone, Internet, wireless, or combinations thereof.

5. The machine of claim 1 wherein said payment accepting means is a pliant currency accepter, credit card reader, check imaging and processing mechanism, or combinations thereof.

6. The machine of claim 1 wherein said printer provides proof of insurance at the time of purchase.

7. The machine of claim 1 wherein said machine further comprises a removable camera secured to said machine.

8. The machine of claim 1 wherein said machine further comprises a flash memory card reader.

9. A system for conducting an insurance transaction comprising:
a. providing a machine according to claim 1;
b. selecting a public location to place said machine;
c. placing said machine in said public location.

10. A method for conducting an insurance transaction comprising the steps of:
a. providing a machine according to claim 1;
b. selecting a public location to place said machine;
c. placing said machine in said public location
d. providing an insurance selection and purchase program on a computer readable medium for said machine;
e. providing an output to indicate proof of purchased insurance.
